(19) United States
(12) Patent Application Publication
(10) Pub. No.: US 2025/0351845 A1
(43) Pub. Date: Nov. 20, 2025

(54) PET FOOD COMPOSITIONS AND MANUFACTURING PROCESSES

(71) Applicant: FARMERS UNION INDUSTRIES, LLC, Redwood Falls, MN (US)

(72) Inventors: Curt GOSSER, Redwood Falls, MN (US); Jeffrey Robert JOHNSON, Redwood Falls, MN (US)

(21) Appl. No.: 19/210,318

(22) Filed: May 16, 2025

Related U.S. Application Data
(60) Provisional application No. 63/649,100, filed on May 17, 2024.

(51) Int. Cl. A23K 10/24; A23K 10/30; A23K 20/147; A23K 40/25; A23K 50/48

(52) U.S. Cl. CPC A23K 10/24; A23K 10/30; A23K 20/147; A23K 40/25; A23K 50/48

(57) ABSTRACT

Disclosed herein are compositions and methods for a pet food composition and manufacturing process. In some examples, pet food includes spray-dried animal plasma and is cooked in a water bath after being extruded. The cooked, extruded pet food mixture may then be cooled in a second water bath, and further shaped and packaged. The cooked pet food mixture may then be cooled in a second water bath.

### CROSS REFERENCE TO RELATED APPLICATIONS

This application claims the benefit of and priority to U.S. Provisional Application Ser. No. 63/649,100 filed May 17, 2024, which is incorporated herein by reference.

### BACKGROUND

Moist pet food often suffers from problems with consistency, such as separation of fats and liquids, being too viscous or not viscous enough, or uneven distribution of ingredients. Including gelling agents such as starches, proteins (for example, wheat gluten or egg albumin), and/or animal plasma can help to stabilize consistency of a pet food product. As an added gelling agent, animal plasma can, when submitted to high cooking temperatures, form a strong gel that has stable water retention capacities. In some typical processes, animal plasma is combined with a food mixture and placed into cans, which are filled, sealed, and finally, cooked fully in the cans (for example, autoclaved at a temperature of 121° F. for about 1 hour) and then left to cool at room temperature (which may take several days). This cooking and cooling process can be time consuming, and ultimately delays when the pet food is ready for shipping and purchase. Further, when some typical processes attempt to cook the mixture prior to placing it in a can, the mixture is prone to undesirably sticking together without the use of a casing. This results in difficulty handling and processing of the mixture, as well as uneven cooking.

### SUMMARY OF THE INVENTION

Disclosed herein are a pet food composition and manufacturing process. The pet food includes animal plasma and is directly cooked in a water bath after being extruded. The cooked, extruded pet food mixture may then be shaped and packaged for shipping, storage, and sale/purchase.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A depicts a schematic of an example pet food manufacturing process.

FIG. 1B depicts a schematic of an alternative example pet food manufacturing process.

FIG. 2A depicts a schematic of an example extruder and cooking water bath of the example pet food manufacturing processes as disclosed herein.

FIG. 2B depicts a schematic of an example extruder, flume, and cooking water bath of the example pet food manufacturing processes as disclosed herein.

FIG. 3 depicts an example method of a pet food manufacturing process.

FIG. 4 depicts a cooling curve of the internal temperature of example mixtures (e.g. sausages) over chiller dwell time, with a non-agitated chiller water bath.

FIG. 5 depicts a cooling curve of the internal temperature of example mixtures (e.g. sausages) over chiller dwell time, with an agitated chiller water bath.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. It should be understood that this invention is not limited to the particular methodology, protocols, and reagents, etc., described herein and as such may vary. The terminology used herein is for the purpose of describing particular embodiments only. The following detailed description is therefore not to be taken in a limiting sense, and the scope of the present disclosure is defined by the appended claims and their equivalents.

Unless defined otherwise, all technical and scientific terms used herein have the same meaning as those commonly understood to one of ordinary skill in the art to which this invention pertains.

For the purposes of this application the following terms shall have the following meanings:

As used herein and in the claims, the singular forms “a,” “an”, and “the” include the plural reference unless the context clearly indicates otherwise.

Other than in the operating examples, or where otherwise indicated, all numbers expressing quantities of ingredients or reaction conditions used herein should be understood as modified in all instances by the term “about.” The term “about” when used herein in connection with numerical values means±20% and with percentages means±2%.

As used herein, the term “comprising” refers to a composition, compound, formulation, or method that is inclusive and does not exclude additional elements or method steps.

As used herein, the term “consisting of” refers to a compound, composition, formulation, or method that excludes the presence of any additional component or method steps.

As used herein, the term “consisting essentially of” refers to a composition, compound, formulation, or method that is inclusive of additional elements or method steps that do not materially affect the characteristic(s) of the composition, compound, formulation, or method.

As used herein, the term percentage means a weight percentage (wt. %), unless otherwise specified.

As used herein, the term “moist pet food” may encompass any type of food intended for animal (e.g. mammal (for example, a dog, cat, or other), reptile, amphibian, bird, fish, or other) consumption that is not an extruded dry food, a baked dry food, a cold pressed dry food, an air dried food, a freeze dried food, or another dry “kibble”-type food. Moist pet foods as described herein may be ultimately presented to the animal in the form of a paté or loaf, a log, a sausage, a link, a chunk or pieces, ropes, a stew, a slurry, or other shape; any of these shapes may be alone, may be mixed with one or more other ingredients, and/or may be served within a gravy, liquid, or jelly formula. Moist pet food may be sold in a can, casing, bag, box, or other type of packaging.

Moist pet food often suffers from problems with consistency, such as separation of fats and liquids, being too viscous or not viscous enough, being too moist or too dry, or uneven distribution of ingredients. Including gelling agents such as starches, proteins (for example, wheat gluten or egg albumin), and/or animal plasma within a mixture can help to stabilize consistency of a pet food product. As an added gelling agent, animal plasma (for example, from a bovine (SDBP), porcine SDPP), poultry (SDCP), mixed species (SDAP), or other animal source) can, when submitted to high cooking temperatures, form a strong gel that has stable water retention capacities. Animal plasma may be sourced from excess blood collected during animal slaughter and/or meat preparation, and therefore the use of the animal plasma provides a use for a waste (the blood) that might otherwise be simply discarded. Animal plasma is separated from other components of the blood, and then spray-dried. Animal plasma contains macronutrients, micronutrients, and bioactive compounds, including proteins, enzymes, and minerals that provide various health and digestibility benefits to the animals that consume it.

Historical processes, in which animal plasma is combined with a food mixture and placed into cans that are filled, sealed, and finally cooked fully in the cans (for example, autoclaved at a temperature of 121° F. for about 1 hour) and then left to cool at room temperature (which may take several days). This typical cooking and cooling process can be time consuming, and ultimately delays when the pet food is ready for shipping and purchase. Further, historical processes that attempt to cook mixtures in methods such as baths often experience the mixture shapes (for example, links, ropes, or other shapes) sticking together and/or losing their shape. This is undesirable for cooking, packaging, maintaining texture, maintaining moisture content, and for maintaining a shape. The historical processes often must utilize a casing (for example, a natural casing, collagen casing, alginate casing, or other casing) to maintain shape of the cooked mixture and to prevent sticking.

Disclosed herein are compositions and related methods for a pet food composition and manufacturing process. The pet food includes spray-dried animal plasma (SDAP) and is cooked in a water bath after being extruded. The cooked, extruded pet food mixture may then be cooled in another water bath. The cooled pet food mixture may then be shaped and packaged for shipping, storage, and sale/purchase. The disclosed processes of mixing the ingredients to form a mixture (in some examples, under vacuum conditions), extruding the mixture, cooking the mixture in a first water bath, and/or cooking the mixture in a second water bath, utilized alone or in combination, can achieve satisfactory gelling properties and cooking properties while taking less time to cook and cool the mixture. In this disclosed method, the mixture is cooked and cooled before packaging (for example, before placing it into cans for storage, shipping, or sale/purchase). These disclosed methods and compositions provide an efficient process for the making of a food product/mixture that has a high palatability, desired texture, that does not require a natural or artificial casing, and that forms a structural strength (e.g. gel strength via the plasma) over a short amount of time.

In an alternative embodiment of the disclosed systems, pet food compositions may or may not include SDAP. The mixture may be stuffed into an artificial (or natural) casing/packaging, which may be crimped, cut, and then cooked in a water bath. The cooked pet food mixture packages may be then cooled in a second water bath. The cooled packages may then be prepared for storage and/or shipping. These disclosed methods and compositions provide an efficient process for the making of a food product/mixture that has a high palatability, desired texture, and that does not require steam or oven cooking.

In a particular example, a food material is mixed with spray-dried animal plasma (for example, at a ratio of between 5 grams and 15 grams of spray-dried plasma per 1 kilogram of food material. The mixing is performed under a vacuum of about 10 mmHg. The mixing may be performed for between 5 minutes with only some ingredients present, and then for a further 15 minutes under the vacuum with all ingredients present. The mixture is then extruded and cooked for between 20 minutes and 40 minutes in a first water bath, wherein the temperature of first water bath is between 185° F. and 205° F. The cooked mixture may then be chilled/cooled for between 30 and 50 minutes in a second water bath, wherein the temperature of the second water bath is between 33° F. and 40° F.

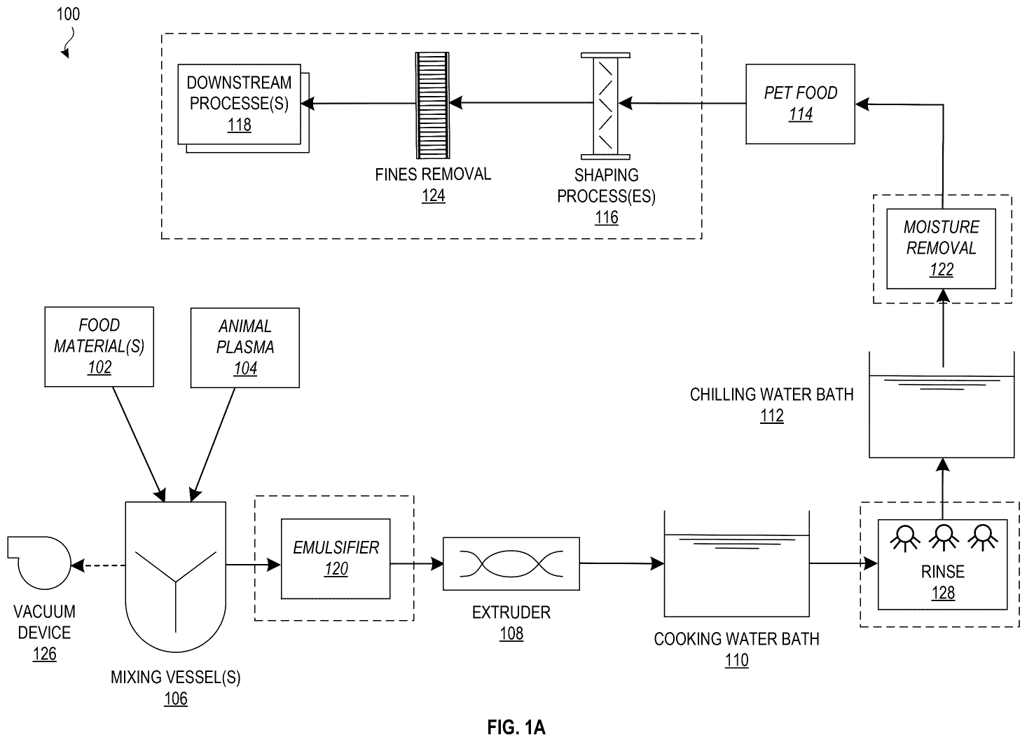

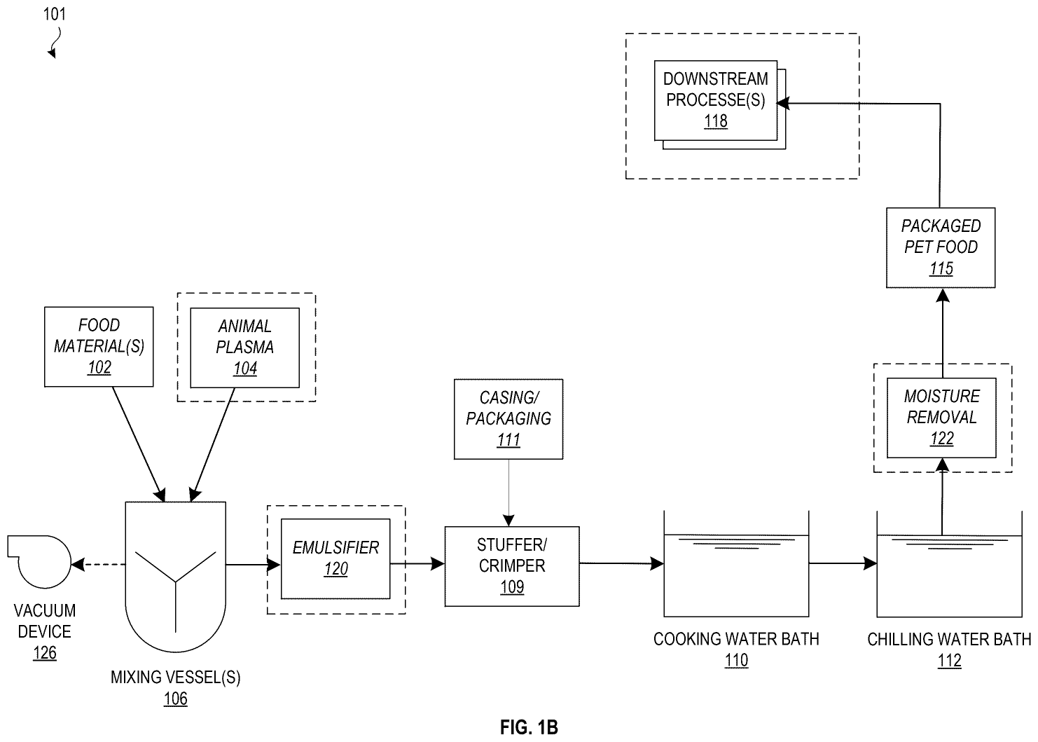

In accordance with principles of this disclosure, FIG. 1A depicts a schematic of an example pet food manufacturing process 100.

Food materials 102 and animal plasma (for example, SDAP) 104 are combined in one or more mixing vessel(s) 106. In some examples, the food materials 102 are in chunk, liquid, slurry, powder, slice, granule, whole, or other shape/form. In some examples, the food materials 102 include one or more animal proteins (for example, meats, or other animal protein types sourced from one or more animal sources such as bovine, porcine, poultry, seafood, or other), vegetables, fruits, vitamins, minerals, grains, tubers, nuts, seeds, supplements, probiotics, pharmaceuticals, broths, binders (for example, egg, flax, and/or others), and/or other ingredients. In some examples, liquids such as animal or plant-based broths or stocks, water, oils, or other liquids may be mixed with the food materials 102 and/or animal plasma 104. In some examples, the animal plasma 104 and food materials 102 are mixed in mixing vessel 106 until the mixture is homogenous. In some examples, the animal plasma 104 and food materials 102 are mixed in mixing vessel 106 until the mixture is emulsified. In some examples, mixing may occur in stages, with some ingredients being food materials 102 and/or animal plasma 104 being mixed together first before others are added. In some examples, different mixing stages may occur under different pressures or vacuums.

In some examples, the animal plasma 104 and food materials 102 are mixed in mixing vessel 106 under vacuum conditions. A vacuum may be created by a vacuum device 126, for example, a vacuum pump, compressor, fan, or other device or piece of equipment capable of inducing a vacuum within mixing vessel 106. In some examples, mixing under vacuum conditions may decrease the amount of air pockets entrained in the resulting mixture. Therefore, the amount (or lack of) a vacuum pulled during the mixing process can affect the density and texture of the mixture. An undesired texture may not be palatable to an animal eating the mixture alone or as part of a final wet pet food. Further, the density and texture affects the ability of the mixture to hold a shape, both on its own and within a liquid or gel (for example, during processing within cooking water bath 110 or chilling water bath 112, or when processed package with a gel or gravy). While a denser, more tightly-packed mixture (e.g. with less air entrainment) may hold together well, but may be unpalatable or may not cook evenly or completely. A denser, more tightly-packed mixture (e.g. with less air entrainment) may not float when placed into a cooking water bath 110 or chilling water bath 112, causing uneven cooking (including overcooked sections which may impact palatability, and undercooked sections which provide a health and safety hazard to handlers of the mixture and animals consuming the mixture) and/or an undesirable surface texture (for example, an undesirable flaky, scaly, or mealy surface texture instead of a substantially smooth, even texture. A mixture that is mixed at the disclosed vacuum conditions may have an ideal amount of entrained air and an ideal density and texture; this mixture may float as it passes through the cooking water bath 110 or chilling water bath 112, contributing to even cooking, easier handling, a desired internal texture/structure (e.g. ideal density and few, if any, bubbles), and a desired external texture.

In some examples, vacuum conditions during mixing within mixing vessel 106 may be about 10 mmHg. In some examples, vacuum conditions during mixing within mixing vessel 106 may be about 15 mmHg. In some examples, vacuum conditions during mixing within mixing vessel 106 may be about 20 mmHg. In some examples, vacuum conditions during mixing within mixing vessel 106 may be at least about 10 mmHg. In some examples, vacuum conditions during mixing within mixing vessel 106 may be at least about 15 mmHg. In some examples, vacuum conditions during mixing within mixing vessel 106 may be at least about 5 mmHg. In some examples, vacuum conditions during mixing within mixing vessel 106 may be no more than about 15 mmHg. In some examples, vacuum conditions during mixing within mixing vessel 106 may be no more than about 10 mmHg. In some examples, vacuum conditions during mixing within mixing vessel 106 may be no more than about 20 mmHg. In some examples, vacuum conditions during mixing within mixing vessel 106 may be between about 5 mmHg and about 30 mm Hg. In some examples, vacuum conditions during mixing within mixing vessel 106 may be between about 5 mmHg and about 20 mm Hg. In some examples, vacuum conditions during mixing within mixing vessel 106 may be between about 5 mmHg and about 15 mm Hg. In some examples, vacuum conditions during mixing within mixing vessel 106 may be between about 10 mmHg and about 20 mm Hg. In some examples, vacuum conditions during mixing within mixing vessel 106 may be between about 20 mmHg and about 30 mm Hg.

In some examples, the spray-dried animal plasma 104 is present at an amount of between about 5 grams and about 15 grams of spray-dried plasma per 1 kilogram of food materials 102. In some examples, the spray-dried animal plasma 104 is present at an amount of between about 2 grams and about 20 grams of spray-dried plasma per 1 kilogram of food materials 102. In some examples, the spray-dried animal plasma 104 is present at an amount of between about 2 grams and about 8 grams of spray-dried plasma per 1 kilogram of food materials 102. In some examples, the spray-dried animal plasma 104 is present at an amount of about 5.85 grams of spray-dried plasma per 1 kilogram of food materials 102. In some examples, the spray-dried animal plasma 104 is present at an amount of at least about 5.85 grams of spray-dried plasma per 1 kilogram of food materials 102. In some examples, the spray-dried animal plasma 104 is present at an amount of at least about 2 grams of spray-dried plasma per 1 kilogram of food materials 102.

In some examples, the spray-dried animal plasma 104 is present at an amount of at least about 5 grams of spray-dried plasma per 1 kilogram of food materials 102. In some examples, the spray-dried animal plasma 104 is present at an amount of at least about 8 grams of spray-dried plasma per 1 kilogram of food materials 102. In some examples, the spray-dried animal plasma 104 is present at an amount of at least about 10 grams of spray-dried plasma per 1 kilogram of food materials 102. In some examples, the spray-dried animal plasma 104 is present at an amount of at least about 15 grams of spray-dried plasma per 1 kilogram of food materials 102. In some examples, the spray-dried animal plasma 104 is present at an amount of no more than about 5.85 grams of spray-dried plasma per 1 kilogram of food materials 102. In some examples, the spray-dried animal plasma 104 is present at an amount of no more than about 2 grams of spray-dried plasma per 1 kilogram of food materials 102. In some examples, the spray-dried animal plasma 104 is present at an amount of no more than about 5 grams of spray-dried plasma per 1 kilogram of food materials 102. In some examples, the spray-dried animal plasma 104 is present at an amount of no more than about 8 grams of spray-dried plasma per 1 kilogram of food materials 102. In some examples, the spray-dried animal plasma 104 is present at an amount of no more than about 10 grams of spray-dried plasma per 1 kilogram of food materials 102. In some examples, the spray-dried animal plasma 104 is present at an amount of no more than about 15 grams of spray-dried plasma per 1 kilogram of food materials 102.

In some examples, the mixture contains about 6 wt. % spray-dried animal plasma 104. In some examples, the mixture contains about 5 wt. % spray-dried animal plasma 104. In some examples, the mixture contains about 10 wt. % spray-dried animal plasma 104. In some examples, the mixture contains between about 3 wt. % spray-dried animal plasma 104 and about 15 wt. % spray-dried animal plasma 104. In some examples, the mixture contains between about 3 wt. % spray-dried animal plasma 104 and about 9 wt. % spray-dried animal plasma 104. In some examples, the mixture contains between about 5 wt. % spray-dried animal plasma 104 and about 10 wt. % spray-dried animal plasma 104. In some examples, the mixture contains between about 5 wt. % spray-dried animal plasma 104 and about 7 wt. % spray-dried animal plasma 104. In some examples, the mixture contains at least about 3 wt. % spray-dried animal plasma 104. In some examples, the mixture contains at least about 5 wt. % spray-dried animal plasma 104.

In some examples, the food materials 102 include one or more binder ingredients. These binder ingredients may provide additional structure and/or texture to the mixture, and may also provide additional nutrition (for example, protein micronutrients, fat, and/or fiber) to the mixture. Non-limiting examples, of binder ingredients include egg, flax, chia, aquafaba, tofu, and/or others.

In some examples, the food materials 102 include egg. In some examples, the mixture contains about 7.5 wt. % egg. In some examples, the mixture contains about 5 wt. % egg. In some examples, the mixture contains about 7.5 wt. % egg. In some examples, the mixture contains about 10 wt. % egg. In some examples, the mixture contains about 7.5 wt. % egg. In some examples, the mixture contains between about 5 wt. % egg and about 10 wt. % egg. In some examples, the mixture contains between about 2 wt. % egg and about 20 wt. % egg. In some examples, the mixture contains between about 7 wt. % egg and about 15 wt. % egg. In some examples, the mixture contains at least about 2 wt. % egg. In some examples, the mixture contains at least about 5 wt. % egg.

In some examples, the food materials 102 include flax (for example, milled or ground flax). In some examples, the flax may have at least 30% protein content, less than 12% moisture content, less than 20% fat content, and at least 23% fiber content. In some examples, the mixture contains about 2 wt. % flax. In some examples, the mixture contains about 3 wt. % flax. In some examples, the mixture contains about 4 wt. % flax. In some examples, the mixture contains about 5 wt. % flax. In some examples, the mixture contains about 6 wt. % flax. In some examples, the mixture contains at least about 0.3 wt. % flax. In some examples, the mixture contains at least about 1 wt. % flax. In some examples, the mixture contains at least about 2 wt. % flax. In some examples, the mixture contains between about 2 wt. % flax and about 6 wt. % flax. In some examples, the mixture contains up to about 6 wt. % flax. In some examples, the mixture contains up to about 10 wt. % flax. In some examples, the mixture contains between about 0.3 wt. % flax and about 10 wt. % flax. In some examples, the mixture contains between about 0.3 wt. % flax and about 6 wt. % flax.

In some examples, the mixture may pass through an optional emulsifying process 120. In some examples, emulsification may aid in even dispersion of the particles of the mixture. In other examples, an emulsifying process may not be required, and may increase the density of the mixture to an undesirable density (for example, such that the mixture will not float) Emulsification may be necessary based on the ingredients of the particular mixture. In examples where it is utilized, emulsification may also reduce the particle size to a size that is more palatable and/or aids in distribution or extrusion, in examples where the food materials 104 have a larger initial size. In an example, the average emulsified particle size is about 2 mm. In some examples, the average emulsified particle size is about 3 mm. In some examples, the average emulsified particle size is about 1 mm. In some examples, the average emulsified particle size is about 0.5 mm. In some examples, the average emulsified particle size is about 3.5 mm. In some examples, the average emulsified particle size is about 2.5 mm. In some examples, the average emulsified particle size is about 1.5 mm. In some examples, the average emulsified particle size is greater than about 0.5 mm. In some examples, the average emulsified particle size is greater than about 1 mm. In some examples, the average emulsified particle size is greater than about 1.5 mm. In some examples, the average emulsified particle size is greater than about 2 mm. In some examples, the average emulsified particle size is less than about 3.5 mm. In some examples, the average emulsified particle size is less than about 3 mm. In some examples, the average emulsified particle size is less than about 2.5 mm. In some examples, the average emulsified particle size is less than about 2 mm. In some examples, the average emulsified particle size is between about 0.5 mm and about 3.5 mm. In some examples, the average emulsified particle size is between about 1 mm and about 3 mm. In some examples, the average emulsified particle size is between about 1.5 mm and about 2.5 mm.

The mixed (and, in some examples, emulsified) mixture is then extruded through extruder 108. Extruder 108 may form a continuous or semi-continuous shape of the mixture. In some examples, cross-sections of the extruded mixture may be round or another desired geometry. In some examples, extruder 108 may include sub-components. In a particular example, the extruder 108 may include a stuffer that feeds a grinder/cutter, having an extruding head that outputs the extruded mixture; the stuffer and grinder may be in-line, for example, when a vacuum stuffer is used to aid in driving the grinder.

In some examples, the extruder 108 may be high-pressure extruder. In some examples, the extruder 108 may be a low-pressure extruder. In some examples, extruder 108 may operate at a pressure that is sufficient to move/drive the mixture throughout its system without exceeding that sufficient pressure by a threshold overage. The extruder 108 operating pressure necessary to move the mixture may be determined based on factors such as temperature, viscosity, and/or other mixture characteristics as well as length, shape, diameter, and or other extruder piping/flow path characteristics. In some examples, the extruder 108 may operate at a pressure of about 100 psig. In some examples, the extruder 108 may operate at a pressure less than about 100 psig. In some examples, the extruder 108 may operate at a pressure greater than about 100 psig. In some examples, the extruder 108 may operate at a pressure less than about 500 psig. In some examples, the extruder 108 may operate at a pressure greater than about 50 psig. In some examples, the extruder 108 may operate at a pressure less than about 20 psig. In some examples, the extruder 108 may operate at a pressure greater than about 20 psig. In some examples, the extruder 108 may operate at a pressure between about 20 psig and about 50 psig. In some examples, the extruder 108 may operate at a pressure between about 20 psig and about 100 psig. In some examples, the extruder 108 may operate at a pressure between about 50 psig and about 100 psig.

In some examples, a first portion of the extruder 108 (at a portion where the mixed/emulsified mixture enters the extruder) includes a hopper that receives the mixture. The hopper may include a flap that opens and closes to adjust a hopper lid flap gap. The degree of opening (open, closed, or a position in between) of the hopper lid flap gap may affect or control the amount of air in the mixture and/or the strength of a vacuum that the mixture is subject to as it enters the extruder. The amount of air in the mixture and/or the strength of a vacuum (for example, a vacuum may be applied at the inlet side of the extruder within ranges of mmHg that were described above for the vacuum that may be pulled during mixing within mixing vessels 106) may affect final texture, density, and/or palatability of the cooked mixture product.

In some examples, the extruder 108 includes a grinder. During extrusion, the mixture may be ground to a selected size. In some examples, the grind size may be about 4 mm. In some examples, the grind size may be between about 2 mm and about 20 mm. In some examples, the grind size may be between about 2 mm and about 6 mm. In some examples, the grind size may be between about 2 mm and about 10 mm. In some examples, the grind size may be at least 1 mm. In some examples, the grind size may be at least 2 mm. In some examples, the grind size may be between about 2 mm and about 6 mm. In some examples, the grind size may be at least 3 mm. In some examples, the grind size may be at least 4 mm. In some examples, the grind size may be up to 20 mm. In some examples, the grind size may be up to 10 mm. In some examples, the grind size may be up to 5 mm. In some examples, the grind size may be up to 4 mm.

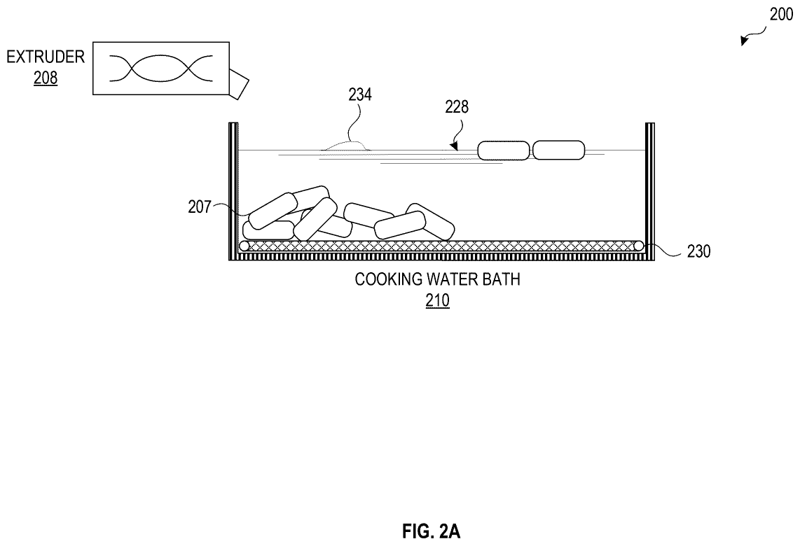

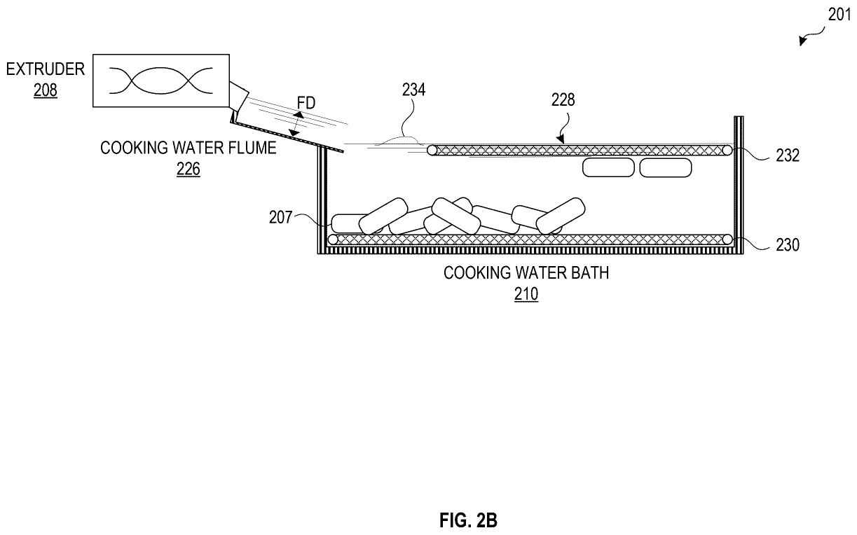

The extruded mixture is cooked in a cooking water bath 110. In some examples, the extruded mixture is extruded directly into the cooking water bath 110. In some examples, the extruded mixture is extruded into a cooking water flume (refer to cooking water flume 226 in FIG. 2B) and is then transferred to cooking water bath 110. The water in the cooking water bath 110 (and cooking water flume 226, where included in the process) is maintained at a temperature configured such that the extruded mixture cooks to a desired (i.e. safe and palatable) “doneness” level. In some examples, cooking water bath 110 is maintained at a temperature of about 203° F. In some examples, cooking water bath 110 is maintained at a temperature of between about 203° F. and about 206° F. In some examples, cooking water bath 110 is maintained at a temperature of between about 200° F. and about 210° F. In some examples, cooking water bath 110 is maintained at a temperature of between about 150° F. and about 212° F. In some examples, cooking water bath 110 is maintained at a temperature of between about 158° F. and about 212° F. In some examples, cooking water bath 110 is maintained at a temperature of between about 185° F. and about 205° F. In some examples, cooking water bath 110 is maintained at a temperature of between about 190° F. and about 212° F. In some examples, cooking water bath 110 is maintained at a temperature of at or below about 212° F. In some examples, cooking water bath 110 is maintained at a temperature of at or below about 205° F. In some examples, cooking water bath 110 is maintained at a temperature of at or below about 190° F. In some examples, cooking water bath 110 is maintained at a temperature of at or below about 195° F. In some examples, cooking water bath 110 is maintained at a temperature of at or below about 185° F. In some examples, cooking water bath 110 is maintained at a temperature of at or below about 180° F. In some examples, cooking water bath 110 is maintained at a temperature of at or above about 205° F. In some examples, cooking water bath 110 is maintained at a temperature of at or above about 195° F. In some examples, cooking water bath 110 is maintained at a temperature of at or above about 190° F. In some examples, cooking water bath 110 is maintained at a temperature of at or above about 185° F. In some examples, cooking water bath 110 is maintained at a temperature of at or above about 180° F. In some examples, cooking water bath 110 is maintained at a temperature of at or above about 170° F. In some examples, cooking water bath 110 is maintained at a temperature of at or above about 160° F. In some examples, cooking water bath 110 is maintained at a temperature of at or above about 158° F. In some examples, cooking water bath 110 is maintained at a temperature of at or above about 150° F.

In some examples, the extruded mixture is cooked (in cooking water bath 110) to an internal temperature of between about 150° F. and about 212° F. In some examples, the extruded mixture is cooked (in cooking water bath 110) to an internal temperature of between about 140° F. and about 212° F. In some examples, the extruded mixture is cooked (in cooking water bath 110) to an internal temperature of between about 158° F. and about 212° F. In some examples, the extruded mixture is cooked (in cooking water bath 110) to an internal temperature of between about 160° F. and about 212° F. In some examples, the extruded mixture is cooked (in cooking water bath 110) to an internal temperature of between about 180° F. and about 212° F. In some examples, the extruded mixture is cooked (in cooking water bath 110) to an internal temperature of between about 150° F. and about 180° F. In some examples, the extruded mixture is cooked (in cooking water bath 110) to an internal temperature of between about 150° F. and about 165° F. In some examples, the extruded mixture is cooked (in cooking water bath 110) to an internal temperature of at least 150° F. In some examples, the extruded mixture is cooked (in cooking water bath 110) to an internal temperature of at least 158° F. In some examples, the extruded mixture is cooked (in cooking water bath 110) to an internal temperature of at least 160° F. In some examples, the extruded mixture is cooked (in cooking water bath 110) to an internal temperature of at least 170° F. In some examples, the extruded mixture is cooked (in cooking water bath 110) to an internal temperature of at least 180° F. In some examples, the extruded mixture is cooked (in cooking water bath 110) to an internal temperature of at least 190° F. In some examples, the extruded mixture is cooked (in cooking water bath 110) to an internal temperature of at least 200° F. In some examples, the extruded mixture is cooked (in cooking water bath 110) to an internal temperature of 160° F. or below. In some examples, the extruded mixture is cooked (in cooking water bath 110) to an internal temperature of 170° F. or below. In some examples, the extruded mixture is cooked (in cooking water bath 110) to an internal temperature of 180° F. or below. In some examples, the extruded mixture is cooked (in cooking water bath 110) to an internal temperature of 180° F. or below. In some examples, the extruded mixture is cooked (in cooking water bath 110) to an internal temperature of 190° F. or below. In some examples, the extruded mixture is cooked (in cooking water bath 110) to an internal temperature of 200° F. or below. In some examples, the extruded mixture is cooked (in cooking water bath 110) to an internal temperature of 212° F. or below.

In some examples, the extruded mixture is cooked in water bath 110 for about 15 minutes. In some examples, the extruded mixture is cooked in water bath 110 for about 18 minutes. In some examples, the extruded mixture is cooked in water bath 110 for about 24 minutes. In some examples, the extruded mixture is cooked in water bath 110 for about 20 minutes. In some examples, the extruded mixture is cooked in water bath 110 for about 28 minutes. In some examples, the extruded mixture is cooked in water bath 110 for between about 10 minutes and 60 minutes. In some examples, the extruded mixture is cooked in water bath 110 for between about 15 minutes and 45 minutes. In some examples, the extruded mixture is cooked in water bath 110 for between about 20 minutes and 40 minutes. In some examples, the extruded mixture is cooked in water bath 110 for between about 10 minutes and 20 minutes. In some examples, the extruded mixture is cooked in water bath 110 for between about 15 minutes and 20 minutes. In some examples, the extruded mixture is cooked in water bath 110 for between about 25 minutes and 35 minutes. In some examples, the extruded mixture is cooked in water bath 110 for at least about 10 minutes. In some examples, the extruded mixture is cooked in water bath 110 for at least about 20 minutes. In some examples, the extruded mixture is cooked in water bath 110 for at least about 25 minutes. In some examples, the extruded mixture is cooked in water bath 110 for at least about 30 minutes. In some examples, the extruded mixture is cooked in water bath 110 for at least about 35 minutes. In some examples, the extruded mixture is cooked in water bath 110 for at least about 40 minutes. In some examples, the extruded mixture is cooked in water bath 110 for at least about 45 minutes. In some examples, the extruded mixture is cooked in water bath 110 for at least about 50 minutes. In some examples, the extruded mixture is cooked in water bath 110 for at least about 60 minutes. In some examples, the extruded mixture is cooked in water bath 110 for no more than about 10 minutes. In some examples, the extruded mixture is cooked in water bath 110 for no more than about 20 minutes. In some examples, the extruded mixture is cooked in water bath 110 for no more than about 25 minutes. In some examples, the extruded mixture is cooked in water bath 110 for no more than about 30 minutes. In some examples, the extruded mixture is cooked in water bath 110 for no more than about 35 minutes. In some examples, the extruded mixture is cooked in water bath 110 for no more than about 40 minutes. In some examples, the extruded mixture is cooked in water bath 110 for no more than about 45 minutes. In some examples, the extruded mixture is cooked in water bath 110 for no more than about 50 minutes. In some examples, the extruded mixture is cooked in water bath 110 for no more than about 60 minutes.

In some examples, the water in cooking water bath 110 (or chilling water bath 112) may include substances such as salts (such as sodium chloride, potassium acetate, and/or others), herbs, spices, or other ingredients, making the water into a brine composition. Such a brine composition may require additional equipment and/or considerations regarding corrosion, scaling, mixing, heating, cooling, etc. in the process.

In some examples, after being cooked in cooking water bath 110, the cooked mixture may be rinsed at a rinse process 128 prior to entering a chilling water bath 112. In examples, the rinse 128 is performed with water, such as freshwater. In some examples, rinse process 128 may include spraying, pouring, dropping, submerging, or otherwise passing the cooked mixture through the rinse water (or passing the rinse water over the cooked mixture). The rinse process 128 may remove particulate, greases and oils, and/or other undesired materials from the surface of the cooked mixture. This may improve surface texture, taste, and reduce the likelihood that particulate, grease, or oils will cause damage or maintenance issues in the downstream chilling water bath 112.

In some examples, the cooked mixture from cooking water bath 110 (and, in some examples, after rinse 128) is cooled/chilled in a chilling water bath 112. In some examples, one or more conveyors, belts, chains, fabrics, screws, augers, moving walls, and/or other means of conveyance mechanically move the cooked mixture pieces from the cooking water bath 110 into the chilling/cooling water bath 112. The water in the chilling water bath 112 is maintained at a temperature configured such that the extruded mixture cools to a desired (i.e. safe and appropriate for downstream processes) temperature. In some examples, the chilling water bath 112 is agitated. In some examples, the chilling water bath 112 is not agitated. In some examples, chilling water bath 112 is maintained at a temperature of about 34° F. In some examples, chilling water bath 112 is maintained at a temperature of between about 30° F. and about 40° F. In some examples, chilling water bath 112 is maintained at a temperature of between about 33° F. and about 42° F. In some examples, chilling water bath 112 is maintained at a temperature of between about 33° F. and about 45° F. In some examples, chilling water bath 112 is maintained at a temperature of between about 35° F. and about 40° F. In some examples, chilling water bath 112 is maintained at a temperature of between about 40° F. and about 45° F. In some examples, chilling water bath 112 is maintained at a temperature of about 34° F. In some examples, chilling water bath 112 is maintained at a temperature of at least about 34° F. In some examples, chilling water bath 112 is maintained at a temperature of at least about 33° F. In some examples, chilling water bath 112 is maintained at a temperature of at least about 35° F. In some examples, chilling water bath 112 is maintained at a temperature of at least about 40° F. In some examples, chilling water bath 112 is maintained at a temperature of no more than about 33° F. In some examples, chilling water bath 112 is maintained at a temperature of no more than about 34° F. In some examples, chilling water bath 112 is maintained at a temperature of no more than about 35° F. In some examples, chilling water bath 112 is maintained at a temperature of no more than about 40° F. In some examples, chilling water bath 112 is maintained at a temperature of no more than about 42° F. In some examples, chilling water bath 112 is maintained at a temperature of no more than about 45° F.

In some examples, the cooked mixture is cooled in chilling water bath 112 for about 30 minutes. In some examples, the cooked mixture is cooled in chilling water bath 112 for about 40 minutes. In some examples, the cooked mixture is cooled in chilling water bath 112 for about 24 minutes. In some examples, the cooked mixture is cooled in chilling water bath 112 for between about 10 minutes and 60 minutes. In some examples, the extruded mixture is cooled in chilling water bath 112 for between about 15 minutes and 45 minutes. In some examples, the extruded mixture is cooled in chilling water bath 112 for between about 20 minutes and 40 minutes. In some examples, the extruded mixture is cooled in chilling water bath 112 for between about 25 minutes and 35 minutes. In some examples, the extruded mixture is cooled in chilling water bath 112 for at least about 10 minutes. In some examples, the extruded mixture is cooled in chilling water bath 112 for at least about 20 minutes. In some examples, the extruded mixture is cooled in chilling water bath 112 for at least about 25 minutes. In some examples, the extruded mixture is cooled in chilling water bath 112 for at least about 30 minutes. In some examples, the extruded mixture is cooled in chilling water bath 112 for at least about 35 minutes. In some examples, the extruded mixture is cooled in chilling water bath 112 for at least about 40 minutes. In some examples, the extruded mixture is cooled in chilling water bath 112 for at least about 45 minutes. In some examples, the extruded mixture is cooled in chilling water bath 112 for at least about 50 minutes. In some examples, the extruded mixture is cooled in chilling water bath 112 for at least about 60 minutes. In some examples, the extruded mixture is cooled in chilling water bath 112 for no more than about 10 minutes. In some examples, the extruded mixture is cooled in chilling water bath 112 for no more than about 20 minutes. In some examples, the extruded mixture is cooled in chilling water bath 112 for no more than about 25 minutes. In some examples, the extruded mixture is cooled in chilling water bath 112 for no more than about 30 minutes. In some examples, the extruded mixture is cooled in chilling water bath 112 for no more than about 35 minutes. In some examples, the extruded mixture is cooled in chilling water bath 112 for no more than about 40 minutes. In some examples, the extruded mixture is cooled in chilling water bath 112 for no more than about 45 minutes. In some examples, the extruded mixture is cooled in chilling water bath 112 for no more than about 50 minutes. In some examples, the extruded mixture is cooled in chilling water bath 112 for no more than about 60 minutes.

Once it has been cooled in chilling water bath 112, the resulting pet food mixture 114 may have desired gelling properties. A desired gel strength may be large enough to hold the pet food mixture 114 in a desired shape without crumbling or falling apart and not so large as to make the pet food mixture 114 difficult to process or to make the pet food mixture unpalatable to animals. Gel strength of the mixture may be measured as defined by AP 820. In some examples, the gel strength may be between 3 N and 15 N. In some examples, the gel strength may be between 1 N and 5 N. In some examples, the gel may be between 0.1 N and 1 N. In some examples, the gel strength may be between 0.1 N and 15 N. In some examples, the gel strength may be dependent at least in part on the maximum temperature the mixture is exposed to during cooking, the time of cooking, and/or the percent inclusion of spray-dried plasma.

In some examples, the pet food mixture 114 may have a desired density. If the pet food mixture 114 is not dense enough, it may fall apart during the cooking process (where it may be lost, may lose its shape, and/or may take on excess water) and/or during packaging, shaping, or other downstream processes. A pet food mixture 114 that is not dense enough or that is too dense may not be palatable to a pet consuming a food product comprising pet food mixture 114. In some examples, the density of the pet food mixture 114 may have a density of about 41.1 lb./ft³. In some examples, the density of the pet food mixture 114 may have a density of at least about 40 lb./ft³.

In some examples, the density of the pet food mixture 114 may have a density of less than about 45 lb./ft³. In some examples, the density of the pet food mixture 114 may have a density of between about 40 lb./ft³ and about 45 lb./ft³. In some examples, the density of the pet food mixture 114 may have a density of between about 30 lb./ft³ and about 50 lb./ft³. In some examples, the density of the pet food mixture 114 may have a density of between about 20 lb./ft³ and about 60 lb./ft³.

In some examples, the cooled mixture is processed at a surface moisture removal process 122. The surface moisture removal process 122 may include, in some examples, one or more blowers, shakers, fans, or other process(es) to remove moisture from the surface of the cooled mixture, for example, by evaporation.

The pet food 114 may be further cut, sliced, diced, rolled, or otherwise processed by one or more shaping process(es) 116. The shaped food may be processed into cubes, a slurry, slices, cylinders, rough shapes, or other desired shapes.

In some examples, the pet food 114 may (in some examples, after shaping) pass through a fines removal process 124. Fines removal 124 may include a shaker conveyor with grate allowing for fines to drop out, a sieve, and/or another process that allows for fines of a size below a particular threshold to drop out.

The processed pet food mixture may then be further processed at one or more downstream process(es) 118. In some examples, downstream processes 118 may include packaging processes, where the pet food may be packaged for storage, shipping, and sale/purchase. The packaging process may package the pet food into cans, tins, bottles, boxes, bags, or other appropriate packaging container types. In some examples, downstream processes 118 may include further mixing or combining the pet food with additional ingredients to form a secondary food mixture. In some examples, downstream processes 118 may include a dehydration process, such as cold pressing, freeze-drying, warm/hot air dehydration, or dehydration processes. Downstream processes 118 may include storage, such as freezing, refrigeration, dry storage, climate-controlled storage, blast chillers, or other appropriate storage facilities. In some examples, downstream processes 118 may include means of measuring and/or moving the pet food prior to and/or after packaging, such as conveyors, cables, rollers, scales, and/or others. In some examples, downstream processes 118 may include processes to ensure safety of the pet food, including metal detectors, temperature monitoring, pathogen testing, and/or others.

FIG. 1B depicts a schematic of an alternative example pet food manufacturing process 101. Where applicable, features of pet food manufacturing process 101 have the same or similar characteristics as those of the same reference number mentioned herein with regards to pet food manufacturing process 100.

In examples of pet food manufacturing process 101, the mixture in mixing vessel 106 may or may include animal plasma 104 and food materials 102. In such examples, the animal plasma 104 may provide the final pet food product with a desired palatability, texture, or other characteristic. In other examples, the mixture in mixing vessel may not include animal plasma 104. In such examples, the animal plasma 104 may not be necessary to aid in the mixture keeping its shape during the cooking and chilling processes, because the mixture is contained within a casing or packaging 111.

In some examples of pet food manufacturing process 101, the mixture may pass through an emulsifier 120. In some examples, the mixture is passed through one or more stuffing and/or crimping operations 109. The mixture may be stuffed into a natural or artificial casing/packaging 111. In a particular example, an artificial casing may include an inedible flexible plastic or plastic-like tube packaging. Once the mixture is stuffed, it may resemble a log or tube filled with mixture. Such a tube/log may be twisted or crimped to separate the tube into links or sections. These links or sections may then be cut to separate them from one another. In some examples, a plastic adhesive tie or metal crimp tie may be placed on each end of each link or section (particularly where the casing 111 is a plastic tube packaging) to prevent mixture from leaking out of the ends.

The separated links/sections may then be cooked in the cooking water bath 110 and subsequently chilled in the chilling water bath 112. In both water baths, the casing/packaging 111 holds the mixture together. In some examples, the exteriors of the links may move through a moisture removal process. In some examples, the resulting packaged pet food 115 may be processed at downstream processes 118, which may include storage, such as freezing, refrigeration, dry storage, climate-controlled storage, or other appropriate storage facilities. In some examples, downstream processes 118 may include packaging processes, where the pet food may be packaged for storage, shipping, and sale/purchase. The packaging process may package the pet food 115 into boxes, bags, or other appropriate packaging container types.

FIG. 2A depicts a schematic 200 of an example extruder 208 and cooking water bath 210 of the example pet food manufacturing processes as disclosed herein.

In some examples, the pieces (for example, sausages, links, etc.) 207 of the extruded mixture exit the extruder 208 and enter directly into a cooking water bath 210. In some examples, one or a series of conveyors 230 (for example, screens, belts, chains, fabrics, and/or other means of conveyance such as screws, augers, or others) along the bottom surface of the cooking water bath 210 mechanically move the cooking mixture pieces 207 along a length of the cooking water bath 210. The conveyor 230 may be made of a permeable material, such as a screen, mesh, fabric, chain-link, or other material.

The pieces 207 may enter the cooking water bath 210 from a height above the cooking water bath 210 (for example, may drop from an extruder 208 that is raised above the cooking water bath 210). This may cause the pieces 207 to become deformed and/or fall apart and lose their shape/integrity (particularly in examples wherein the pieces 207 are uncased).

In some examples, the raw, uncooked pieces 207 sink initially upon entering the cooking water bath. The pieces 207 may begin to float/become buoyant as they cook. When this happens, they no longer contact the conveyor 230 and may not move along the length of the cooking water bath 210 efficiently. This may lead to uneven cooking and levels of doneness among the pieces 207, as well as causing blockages of the pieces 207 in the cooking water bath 210. Further, when the pieces 207 float, a portion of each piece 207 may rise above the surface 228 of the water in the cooking water bath 210. Each floating piece 207 that has an unsubmerged portion and a submerged portion may exhibit uneven cooking and uneven moisture properties between the submerged and unsubmerged portions. In some examples, a piece 207 that is too dense may sink even when cooked, and may not become buoyant. This can cause the pieces 207 to pile, and may contribute to uneven cooking and poor internal and external texture of the cooked pieces.

FIG. 2B depicts a schematic 201 of an example extruder 208, cooking water flume 226, and cooking water bath 210 of the example pet food manufacturing processes as disclosed herein. Where applicable, features depicted in schematic 201 have the same or similar characteristics as those of the analogous reference number (for example, cooking water bath 110 and cooking water bath 210) mentioned herein with regards to pet food manufacturing processes 100 and/or 101.

The pieces (for example, sausages, links, etc.) 207 of the extruded mixture may exit the extruder 208 (for example, from a height above the cooking water bath 210) and may enter a cooking water flume 226. The cooking water flume 226 may contain a flow of water at a temperature equal to the temperature of the water in the cooking water bath 210. The flume depth FD of the water in the cooking water flume 226 may be sufficient to move the uncooked/raw pieces 207 along the length of the cooking water flume 226 and/or to partially cook the exterior of each piece 207. This partial cooking of the exterior of each piece 207 may contribute to the rigidity and/or physical durability of the pieces 207, causing them to better retain their shape and to hold together better as they enter the cooking water bath 210. In some examples, the flume depth FD is about 1 inch. In some examples, the flume depth is greater than 1 inch. In some examples, the flume depth is less than 1 inch.

The cooking water flume 226 may be sloped from the exit of the extruder 208 to the entrance of the cooking water bath 210 and may provide a gentler entry of the pieces 207 into the cooking water bath 210 (which may further cause the pieces 207 to better retain their shape and hold together as they enter the cooking water bath 210). In some examples, the flow of liquid within the cooking water bath 210 and the geometry/position of the cooking water bath 210 and its components may cause a wave 234 to form at the surface 228. In such examples, the extruder 208 and/or cooking water flume 226 are positioned such that the pieces 207 enter the liquid upstream of the wave 234 to avoid the piece 207 sticking to the interior surfaces of the cooking water bath 210. In some examples, a similar wave phenomena may occur in a chilling water bath, and similar positioning of the entry point of the pieces to be cooled may be beneficial.

In some examples, one or a series of conveyors 230 along the bottom surface of the cooking water bath 210 mechanically move the cooking mixture pieces 207 along a length of the cooking water bath 210. In some examples, one or a series of hold-down conveyors 232 (for example, screens, belts, chains, fabrics, and/or other means of conveyance) are oriented just below the surface 228 of the water in the cooking water bath. The hold-down conveyor 232 may be made of a permeable material, such as a screen, mesh, fabric, chain-link, or other material. In some examples, the hold-down conveyor 232 may be made of the same material as conveyor 230. In some examples, the hold-down conveyor 232 may be driven at the same speed as the conveyor 230.

As the pieces 207 begin to float/become buoyant as they cook, they may rise and contact hold-down conveyor 232. When this happens, movement and contact with hold-down conveyor 232 may cause the buoyant pieces 207 to move along the length of the cooking water bath 210 more efficiently, preventing blockages of the pieces 207 in the cooking water bath 210. Further, when the pieces 207 rise and contact hold-down conveyor 232 below the surface 228, the entirety of each piece 207 remains submerged below the surface 228 of the water in the cooking water bath 210. This contributes to more even cooking and moisture properties within each piece 207.

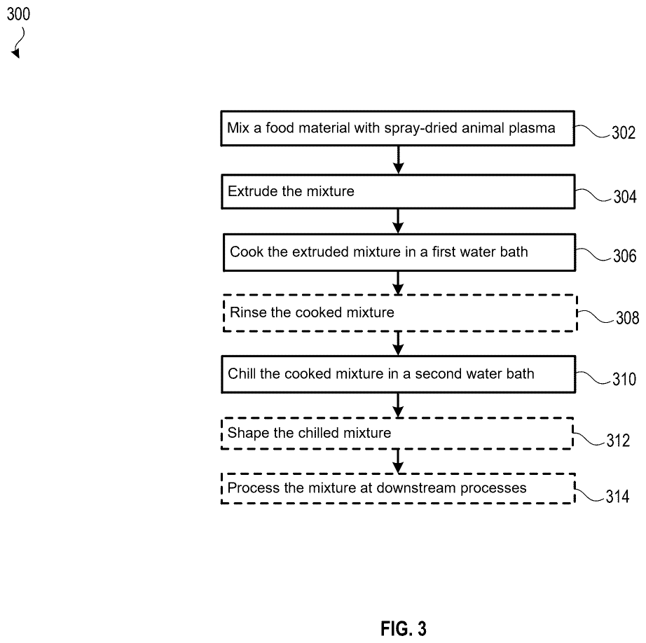

FIG. 3 depicts an example method 300 of a pet food manufacturing process. At operation 302, one or more food materials are mixed with spray-dried animal plasma (SDAP) to create an initial mixture. In some examples, the spray-dried animal plasma comprises porcine plasma. The food material may include at least an animal protein. The food material may include a plant-based material. In some examples, the plant-based material includes flax. The food material may include a liquid. In some examples, the spray-dried plasma is present at an amount of between 5 grams and 15 grams of spray-dried plasma per 1 kilogram of food material. In some examples, the spray-dried plasma is present at an amount of 5.85 grams spray-dried plasma per 1 kilogram of food material. In some examples, the food material comprises egg.

Mixing the food material with the spray-dried animal plasma may be performed under vacuum conditions. In some examples, the vacuum conditions comprise a vacuum between 5 mmHg and 15 mmHg.

In some examples, the initial mixture has a moisture content of between 58 wt. % and 62 wt. %.

At operation 304, the initial mixture is extruded to create an extruded mixture. In some examples, the mixture is emulsified prior to extrusion. In some examples, the initial mixture (and/or an emulsified mixture) is subjected to a vacuum prior to extrusion.

At operation 306, the extruded mixture is cooked in a first water bath to create a cooked mixture. In some examples, the temperature of the first water bath is between 185° F. and 205° F. In some examples, the temperature of the first water bath is about 195° F. In some examples, the temperature of the first water bath is at least 185° F. In some examples, the temperature of the first water bath is between 200° F. and 210° F. In some examples, the extruded mixture is cooked in the first water bath for between 15 minutes and 45 minutes. In some examples, the extruded mixture is cooked in the first water bath for between 15 minutes and 20 minutes. Cooking the extruded mixture may include cooking the extruded mixture until an internal temperature of the extruded mixture is at least 158° F. In some examples, cooking the extruded mixture may include cooking the extruded mixture until an internal temperature of the extruded mixture is between 158° F. and 212° F.

In some examples, the cooked mixture may be rinsed (e.g. at operation 308) to create a rinsed cooked mixture.

At operation 310, the cooked mixture (in some examples, a rinsed cooked mixture) is chilled/cooled in a second water bath to create a cooled mixture. In some examples, the temperature of the second water bath is between 30° F. and 40° F. In some examples, the temperature of the second water bath is 34° F. In some examples, the cooked mixture is cooled in the second water bath for between 15 minutes and 45 minutes.

In some examples, the cooled/chilled mixture is processed at a moisture removal process to create a dried mixture. For example, a blower, shaker, fan, other process, or combination of processes may be used to remove surface moisture from the cooled/chilled mixture.

In some examples, the chilled mixture (in some examples, the dried mixture) may be shaped (e.g. at operation 312) to create a shaped mixture. In some examples, shaping includes cutting or another shaping process to achieve a desired shape and texture.

In some examples, the shaped mixture may be processed at a fines removal process. For example, a shaker conveyor (e.g. a shaker conveyor with a grate), sieve, other process, or combination of processes may be utilized to cause fines (e.g. shapes with a particle/piece size less than a threshold size) to drop out and become separated from shapes of/greater than a desired size.

In some examples, the shaped mixture may be sent through one or more downstream processes (e.g. operation 314). In some examples, the shaped mixture may be combined/mixed with one or more additional ingredients to form a secondary mixture (for example, additional food products such as meat, vegetables, sauce, gravy, vitamins/minerals, and/or other suitable ingredients). In some examples, the shaped mixture and/or secondary mixture may be packaged for storage, shipping, and/or purchase/sale. In some examples, a package may be a can, bag, box, jar, or other desired form of packaging.

In some examples, moisture content of the mixture is important throughout the process, and to the final product. For example, an initial moisture content (for example, after mixing) that is too low or too high may not perform (for example, may be too hard or soft, may not hold together well, etc.) during cooking, cooling, and other processes. A final moisture content (for example, after chilling and/or moisture removal) that is too low or too high may not hold together, may be too soft or hard, may leak/seep/weep moisture, may not be palatable, may not be shapeable, or may otherwise not be suitable. Moisture content is affected by the types and content of food materials, animal plasma, and any other ingredients included in the mixture. Moisture content may also be affected by a level of vacuum applied to the mixing and/or extruding processes. Moisture content may also be affected by various processes such as: a temperature and/or duration of a cooking water bath, rinse, chilling water bath, and/or moisture removal process. In some examples, the moisture content of the mixture (for example, prior to cooking) may be between about 60.5 wt. % and about 63.5 wt. %. In some examples, the moisture content of the mixture (for example, prior to cooking) may be between about 60 wt. % and about 65 wt. %. In some examples, the moisture content of the mixture (for example, prior to cooking) may be between about 58 wt. % and about 65 wt. %. In some examples, the moisture content of the mixture (for example, prior to cooking) may be between about 58 wt. % and about 62 wt. %. In some examples, the moisture content of the mixture (for example, prior to cooking) may be between about 56 wt. % and about 70 wt. %. In some examples, the moisture content of the mixture (for example, prior to cooking) may be at least about 56 wt. %. In some examples, the moisture content of the mixture (for example, prior to cooking) may be at least about 58 wt. %. In some examples, the moisture content of the mixture (for example, prior to cooking) may be at least about 60 wt. %. In some examples, the moisture content in the final pet food (for example, pet food 114) may be about 1% (in some examples, up to 5%) higher than that of the pre-cooked mixture, as moisture may be picked up during the cooking, rinsing, and/or chilling processes. The percentages noted above may be adjusted accordingly for the final pet food product. If too much moisture is picked up during the cooking, rinsing, and/or chilling processes, the pet food product may have undesirable characteristics, as noted above.

### EXAMPLES

### Example 1

In Example 1, an example mixture was formed, cooked, and cooled in a process as described above. The example mixtures were pet food turkey wieners/sausages that were fully cooked in a hot water bath (e.g. until an internal temperature reached at least 175° F. and until any pink color was eliminated in the center of each sausage). The sausages were then cooled in a chilled water bath until an internal temperature reached no greater than 40° F.

The vacuum mixer utilized was a Model 510 (6000 lb. vacuum mixer/blender), available from AMFEC at 4923 E Linden St., Caldwell, ID 83605. The extruder utilized was a Vemag Waterwheel 24 Outlet extruder, available from Reiser at 725 Dedham Street, Canton, MA 02021. Where utilized, the emulsifier was a Comvair 334 emulsifier, available from Reiser at 725 Dedham Street, Canton, MA 02021. The water cooker utilized was a BPF-4232 (Breaded Products Fryer), available from Heat and Control at 21121 Cabot Boulevard, Hayward, CA 94545. The cooking water utilized was tap water. The water chiller utilized was a BPF-6042 (Breaded Products Fryer), available from Heat and Control at 21121 Cabot Boulevard, Hayward, CA 94545. Chilling water utilized was iced tap water.

The density of the cooked sausages measured about 41.1 lb./ft³. The cooked sausages were generally cylindrical in shape.

TABLE 1
Conditions and Data for Example Sausages 1

| Test # | 1 |
|---|---|
| Product Type | Turkey Weiner |
| Moisture Content (%) | 62 |
| Piece Wt. (G) | 75.0 |
| Belt Loading (lbs/sqft) | 15.5 |
| Product Temp. in (° F.) | 70 |
| Length (inches/mm) | 4.0/100 |
| Product Dia. (inches/mm) | 1.0/26 |
| BPF-1205 as Water Cooker | |
| Dwell Time (min) | 15 min |
| Pack Depth (in.) | 4.5 |
| Number of Pieces Deep | 4-5 |
| Process Temp (° F.) | 200 |
| Infeed Inlet Valve | 100% |
| Intermediate Inlet Valve | 4 turns open |
| Product Discharge Temp. (° F.) | 175-181 |
| Piece Wt (G) | 80.0 |
| Cook Yield % | 107% |
| Water Chiller V-Mag with Ice Water | |
| Total Dwell Time (min) | — |
| Water Temp (° F.) | — |
| Product Discharge Temp. (° F.) | — |
| Piece Wt (G) | 80.0 |
| Chilled Yield % | 100% |
| Total Yield | 107% |

As shown in Table 1, the cook/dwell time necessary to achieve an internal temperature of at least 175° F. was about 15 minutes. As also shown in Table 1, total yield was greater than 100%.; this was due to the sausages absorbing water during cooking and/or cooling.

Observations during this Example included that as the sausages exited the extruder and fell onto each other in the cooking water bath they formed a bed of sausages the sausage pieces would then curl and subsequently straighten at least partially during the cooking process some pieces remained curled or curved and did not straighten. The sausages became buoyant in the cooking water bath at around 145° F. internal temperature EG about halfway through the cooking cycle.

### Example 2

In Example 2, an example mixture was formed, cooked, and cooled in a process as described above and in accordance with the process and equipment described in Example 1. The density of the cooked sausages measured about 41.1 lb./ft³. The cooked sausages were generally cylindrical in shape. Dimensions of the cooked sausages were about 1.5 in. in diameter and about 4.0 in. long.

TABLE 2
Conditions and Data for Example Sausages 2

| Test # | 2 |
|---|---|
| Product Type | Turkey Weiner |
| Moisture Content (%) | 62 |
| Piece Wt. (G) | 75.0 |
| Belt Loading (lbs/sqft) | 19 |
| Product Temp. in (° F.) | 75-81 |
| Length(inches/mm) | 4.0/100 |
| Product Dia. (inches/mm) | 1.0/26 |
| BPF-1205 as Water Cooker | |
| Dwell Time (min) | 15 min |
| Pack Depth (in.) | 5.5 |
| Number of Pieces Deep | 5-6 |
| Process Temp (° F.) | 200 |
| Infeed Inlet Valve | 100% |
| Intermediate Inlet Valve | 4 turns open |
| Product Discharge Temp. (° F.) | 183-186 |
| Piece Wt (G) | 80.0 |
| Cook Yield % | 107% |
| Water Chiller V-Mag with Ice Water | (No Agitation) |
| Total Dwell Time (min) | 31 |
| Water Temp (° F.) | 34-37 |
| Product Discharge Temp. (° F.) | 39 |
| Piece Wt (G) | 80.0 |
| Chilled Yield % | 100% |
| Total Yield | 107% |

As shown in Table 2, the cook/dwell time necessary to achieve an internal temperature of at least 175° F. was about 15 minutes. As also shown in Table 2, the chill time necessary to achieve an internal temperature of no greater than 40° F. was about 31 minutes when the chilling water bath was not agitated. As also shown in Table 2, total yield was greater than 100%.; this was due to the sausages absorbing water during cooking and/or cooling.

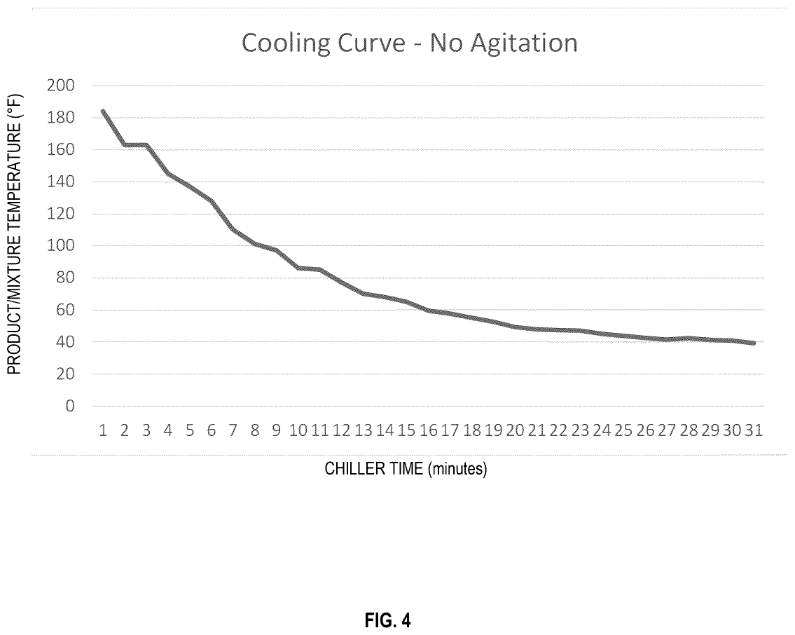

FIG. 4 depicts a cooling curve of the internal temperature of the sausages of Example 2 over the chiller dwell time. As shown in FIG. 4, at about 31 minutes, the internal temperature of the sausages is reduced to about 39° F.

Similar observations were made as those discussed regarding Example 1. Further, it was observed that the sausages floated for about one (1) minute after becoming buoyant, and then sank.

### Example 3

In Example 3, an example mixture was formed, cooked, and cooled in a process as described above and in accordance with the process and equipment described in Example 1. In Example 3, the cooling water bath was agitated periodically, with one-minute intervals between agitations. The density of the cooked sausages measured about 41.1 lb./ft³. The cooked sausages were generally cylindrical in shape. Dimensions of the cooked sausages were between about 1.25 in. and about 1.5 in. in diameter and were between about 3.75 in. and about 4.0 in. long.

TABLE 3
Conditions and Data for Example Sausages 3

| Test # | 3 |
|---|---|
| Product Type | Turkey Weiner |
| Moisture Content (%) | 59 |
| Piece Wt. (G) | 75.0 |
| Belt Loading (lbs/sqft) | 19 |
| Product Temp. in (° F.) | 74-85 |
| Length(inches/mm) | 4.0/100 |
| Product Dia. (inches/mm) | 1.0/26 |
| BPF-1205 as Water Cooker | |
| Dwell Time (min) | 15 min |
| Pack Depth (in.) | 5.5 |
| Number of Pieces Deep | 5-6 |
| Process Temp (° F.) | 200 |
| Infeed Inlet Valve | 100% |
| Intermediate Inlet Valve | 4 turns open |
| Product Discharge Temp. (° F.) | 185-187 |
| Piece Wt (G) | 80.0 |
| Cook Yield % | 107% |
| Water Chiller V-Mag with Ice Water | (Agitated) |
| Total Dwell Time (min) | 24 |
| Water Temp (° F.) | 34-37 |
| Product Discharge Temp. (° F.) | 40 |
| Piece Wt (G) | 80.0 |
| Chilled Yield % | 100% |
| Total Yield | 107% |

As shown in Table 3, the cook/dwell time necessary to achieve an internal temperature of at least 175° F. was about 15 minutes. As also shown in Table 3, the chill time necessary to achieve an internal temperature of no greater than 40° F. was about 24 minutes when the chilling water bath was agitated. As also shown in Table 3, total yield was greater than 100%.; this was due to the sausages absorbing water during cooking and/or cooling.

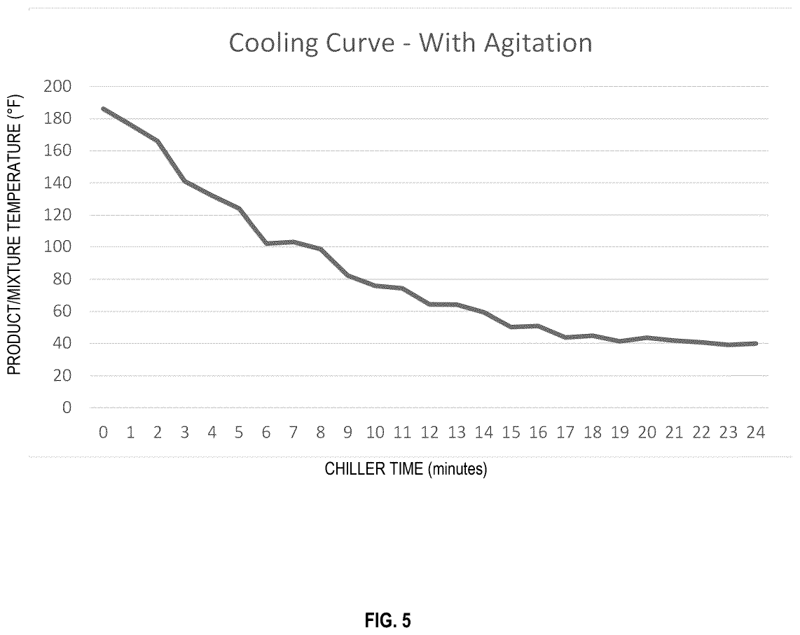

FIG. 5 depicts a cooling curve of the internal temperature of the sausages of Example 3 over the chiller dwell time. As shown in FIG. 5, at about 24 minutes, the internal temperature of the sausages is reduced to about 40° F.

Similar observations were made as those discussed regarding Example 1.

### Example 4

In Example 4, eight (8) example mixtures were formed, cooked, and cooled in a process as described above. The example mixtures were pet food turkey wieners/sausages that were mixed under vacuum conditions, processed in an emulsifier, mixed under vacuum conditions, extruded into a hot water bath, and fully cooked in the hot water bath (e.g. until an internal temperature reached at least 175° F. and until any pink color was eliminated in the center of each sausage). The sausages were then cooled in a chilled water bath until an internal temperature reached no greater than 40° F.

The vacuum mixer utilized was a Model 510 (6000 lb vacuum mixer/blender), available from AMFEC at 4923 E Linden St., Caldwell, ID 83605. The extruder utilized was a Vemag Waterwheel 24 Outlet extruder, available from Reiser at 725 Dedham Street, Canton, MA 02021. Where utilized, the emulsifier was a Comvair 334 emulsifier, available from Reiser at 725 Dedham Street, Canton, MA 02021. The water cooker utilized was a BPF-4232 (Breaded Products Fryer), available from Heat and Control at 21121 Cabot Boulevard, Hayward, CA 94545. The cooking water utilized was tap water. The water chiller utilized was a BPF-6042 (Breaded Products Fryer), available from Heat and Control at 21121 Cabot Boulevard, Hayward, CA 94545. Chilling water utilized was iced tap water.

Test 1 corresponds to a control test, which is a recipe and method to approximate an existing pet food product. Tests 2 through 8 correspond to variations from the control Test 1. The physical properties of each test mixture/sausage were observed and compared, including how well each sausage held their shape, whether the sausages included air bubbles, whether the sausages floated during the cooking and/or chilling processes, and other characteristics. To observe the sausages' characteristics, they were compared as cut (1) length wise with a serrated blade, (2) length wise with a smooth blade, (3) into roughly one-inch cubes with a serrated blade, and (4) into roughly one-inch cubes with a smooth blade.

TABLE 4
Conditions for Example Sausages 4

| | Test 1: | | | | | | | |
|---|---|---|---|---|---|---|---|---|
| | Control | | | | | | | |
| Variable | Recreate | Test 2 | Test 3 | Test 4 | Test 5 | Test 6 | Test 7 | Test 8 |
| Mixing | High 26″ | Low 8″ | Low 8″ | High 26″ | None | High 26″ | Low 9″ | Low 18″ |
| Vacuum | mercury | mercury | mercury | mercury | | mercury | mercury | mercury |
| Emulsifier | High/Closed | High/Closed | Low/Open | Low/Open | None | None | None | None |
| Plate Size | | | | | | | | |
| Seydelman | Plate Size | Plate Size | Plate Size | Plate Size | | | | |
| Breaker | Convair | Convair | Convair | Convair | | | | |
| S10 (24 mm) | Breaker | Breaker | Breaker | Breaker | | | | |
| R31 (12 mm) | (25 mm) | (25 mm) | (25 mm) | (25 mm) | | | | |
| S80 (8 mm) | | | | | | | | |
| R80 (8 mm) | S60 | S60 | S30(19 mm) | S30 | | | | |
| | (13.5 mm) | (13.5 mm) | | (19 mm) | | | | |
| | R144 | R144 | R60(13.5 | R60 | | | | |
| | (8 mm) | (8 mm) | mm) | (13.5 mm) | | | | |
| | High 75 | Low 50 | Low 50 | High 75 | None | High 75 | Low 50 | Low 70 |
| Stuffer | Vac level | vac level | vac level for | vac | Will not | vac | vac | vac |
| Vacuum | | | pulling | level | use vac | level | level | level |
| | | | product into | | to pull | | | |
| | | | hopper. | | product | | | |
| | | | | | into hopper | | | |
| | | | | | 60 vac | | | |
| | | | | | for DS | | | |
| | | for pulling | 60 vac for DS | for pulling | | for | for | for |
| | | product into | | product | | pulling | pulling | pulling |
| | | hopper. | | into hopper. | | product | product | product |
| | | | | | | into | into | into |
| | | | | | | hopper. | hopper. | hopper. |
| | | 60 vac for | | Max vac for | | Max | Max | Max |
| | | DS. | | pulling | | vac for | vac for | vac for |
| | | | | product | | pulling | pulling | pulling |
| | | | | into DS. | | product | product | product |
| | | | | | | into DS. | into DS. | into DS. |
| Hopper lid | Control | Open/High | Open/High | Closed/Low | None | Closed/Low | Open/High | Open/High |
| flap gap | Closed/Low | 20 mm | 20 mm | 3 mm | | 3 mm | 20 mm | 20 mm |
| | 3 mm | | | | | | | |

Observations included that the resulting sausages from Tests 3, 6, and 7 most closely approximated the appearance and texture of the control Test 1. It was also observed that sausages from Tests 1, 2, and 3 exhibited desirable processing characteristics, including forming and sinking during cooking. Test 6 exhibited fair processing characteristics. Test 7 also exhibited less fair processing characteristics, including difficulty forming, and including floating immediately during the cooking process. Test 5 exhibited the least desirable processing characteristics, including difficulty forming, and including floating immediately during the cooking process, and not holding its shape when cubed.

For the purposes of this application, directional terms such as “upper,” “lower,” “upward,” and “downward” are intended to be descriptive with reference to the disclosure above and, where applicable, in relation to the orientation shown in the Figures for clarity. The examples as practiced and included in the scope of the claims may include examples where the systems and devices are in a different orientation.

While particular uses of the technology have been illustrated and discussed above, the disclosed technology can be used with a variety of environments in accordance with many examples of the technology. The above discussion is not meant to suggest that the disclosed technology is only suitable for implementation within the environments shown and described above. As should be appreciated, the various aspects described with respect to the figures herein are not intended to limit the technology to the particular aspects described. Accordingly, additional configurations can be used to practice the technology herein and/or some aspects described can be excluded without departing from the methods and systems disclosed herein.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or operations are disclosed only as illustrative aspects. The scope of the technology is defined by the following claims and any equivalents therein. Examples of the disclosure may be described according to the following aspects.

Aspect 1. A method, comprising: mixing a food material with spray-dried animal plasma to create an initial mixture; extruding the initial mixture to create an extruded mixture; cooking the extruded mixture in a first water bath to create a cooked mixture, wherein the temperature of first water bath is at least 185° F.; and chilling the cooked mixture in a second water bath to create a cooled mixture, wherein the temperature of the second water bath is between 30° F. and 40° F.

Aspect 2. The method of aspect 1, wherein the food material comprises an animal protein.

Aspect 3. The method of aspect 2, wherein the food material further comprises a plant-based material.

Aspect 4. The method of aspect 3, wherein the plant-based material comprises flax, and wherein the initial mixture comprises between 2 wt. % and 6 wt. % flax.

Aspect 5. The method of aspect 2, wherein the food material further comprises a liquid.

Aspect 6. The method of any of aspects 1-5, wherein the food material comprises egg, and wherein the initial mixture comprises between at least 3 wt. % egg.

Aspect 7. The method of any of aspects 1-6, wherein the spray-dried animal plasma is present at an amount of between 5 grams and 15 grams of spray-dried plasma per 1 kilogram of food material.

Aspect 8. The method of any of aspects 1-7, wherein the initial mixture comprises between 3 wt. % and 9 wt. % spray-dried animal plasma.

Aspect 9. The method of any of aspects 1-8, wherein the spray-dried animal plasma comprises porcine plasma.

Aspect 10. The method of any of aspects 1-9, wherein mixing the food material with the spray-dried animal plasma is performed under vacuum conditions.

Aspect 11. The method of aspect 10, wherein the vacuum conditions comprise a vacuum between 5 mmHg and 15 mm Hg.

Aspect 12. The method of any of aspects 1-11, wherein the temperature of the first water bath is between 200° F. and 210° F.

Aspect 13. The method of any of aspects 1-12, wherein the extruded mixture is cooked in the first water bath for between 15 minutes and 30 minutes.

Aspect 14. The method of any of aspects 1-13, wherein cooking the extruded mixture comprises cooking the extruded mixture until an internal temperature of the cooked mixture is at least 158° F.

Aspect 15. The method of aspect 14, wherein cooking the extruded mixture comprises cooking the extruded mixture until an internal temperature of the cooked mixture is between 158° F. and 212° F.

Aspect 16. The method of any of aspects 1-15, wherein the extruded mixture is cooled in the second water bath for between 15 minutes and 45 minutes.

Aspect 17. The method of any of aspects 1-16, further comprising rinsing the cooked mixture prior to chilling the cooked mixture.

Aspect 18. The method of any of aspects 1-17, wherein the initial mixture has a moisture content of between 58 wt. % and 62 wt. %.

Aspect 19. A method, comprising: mixing a food material to create a mixed food material, wherein the food material comprises an animal protein; stuffing the mixed food material into a casing package to create a stuffed casing package; forming the stuffed casing package into a plurality of links; separating each of the plurality of links from one another to form a plurality of separated links; cooking the plurality of separated links in a first water bath to form a plurality of cooked links, wherein the temperature of first water bath is between 185° F. and 205° F.; and chilling the plurality of cooked links in a second water bath to form a plurality of cooled links, wherein the temperature of the second water bath is between 33° F. and 40° F.

Aspect 20. The method of aspect 19, further comprising mixing the food material with spray-dried plasma.

Aspect 21. The method of any of aspects 19-20, wherein the food material further comprises a plant-based material.

Aspect 22. The method of any of aspects 19-21, wherein the food material further comprises a liquid.

What is claimed is:

1. A method, comprising:
mixing a food material with spray-dried animal plasma to create an initial mixture;
extruding the initial mixture to create an extruded mixture;
cooking the extruded mixture in a first water bath to create a cooked mixture, wherein the temperature of first water bath is at least 185° F.; and
chilling the cooked mixture in a second water bath to create a cooled mixture, wherein the temperature of the second water bath is between 30° F. and 40° F.

2. The method of claim 1, wherein the food material comprises an animal protein.

3. The method of claim 2, wherein the food material further comprises a plant-based material.

4. The method of claim 3, wherein the plant-based material comprises flax, and wherein the initial mixture comprises between 2 wt. % and 6 wt. % flax.

5. The method of claim 2, wherein the food material further comprises a liquid.

6. The method of claim 1, wherein the food material comprises egg, and wherein the initial mixture comprises between at least 3 wt. % egg.

7. The method of claim 1, wherein the spray-dried animal plasma is present at an amount of between 5 grams and 15 grams of spray-dried plasma per 1 kilogram of food material.

8. The method of claim 1, wherein the initial mixture comprises between 3 wt. % and 9 wt. % spray-dried animal plasma.

9. The method of claim 1, wherein the spray-dried animal plasma comprises porcine plasma.

10. The method of claim 1, wherein mixing the food material with the spray-dried animal plasma is performed under vacuum conditions.

11. The method of claim 10, wherein the vacuum conditions comprise a vacuum between 5 mmHg and 15 mm Hg.

12. The method of claim 1, wherein the temperature of the first water bath is between 200° F. and 210° F.

13. The method of claim 1, wherein the extruded mixture is cooked in the first water bath for between 15 minutes and 30 minutes.

14. The method of claim 1, wherein cooking the extruded mixture comprises cooking the extruded mixture until an internal temperature of the cooked mixture is at least 158° F.

15. The method of claim 14, wherein cooking the extruded mixture comprises cooking the extruded mixture until an internal temperature of the cooked mixture is between 158° F. and 212° F.

16. The method of claim 1, wherein the extruded mixture is cooled in the second water bath for between 15 minutes and 45 minutes.

17. The method of claim 1, further comprising rinsing the cooked mixture prior to chilling the cooked mixture.

18. The method of claim 1, wherein the initial mixture has a moisture content of between 58 wt. % and 62 wt. %.
